(19) United States
(12) Patent Application Publication
(10) Pub. No.: US 2026/0114424 A1
(43) Pub. Date: Apr. 30, 2026

(54) Boots with suspenders for protecting a dog’s paws

(71) Applicant: Megumi Nagae, Omaha, NE (US)

(72) Inventor: Megumi Nagae, Omaha, NE (US)

(21) Appl. No.: 18/928,389

(22) Filed: Oct. 28, 2024

(51) Int. Cl. A01K 13/00

(52) U.S. Cl. CPC A01K 13/007

(57) ABSTRACT

Boots with suspenders designed to protect a dog's paws during walks wherein the boots are designed with zippers for easier access. The boots with suspenders also have hook and loop fasteners and detachable buckles which prevent dogs from wriggling out of the boots. The harness also has draw strings which prevent snow and water from getting into the boots.

### BACKGROUND OF THE INVENTION

The present subject matter are boots with suspenders designed to protect a dog's paws during walks. There are many hazards for a dog's paws outside of their owner's home. Some surfaces are too hot in the summertime or too cold in the wintertime. Hazards like shards of glass or sharp rocks can injure a dog's paws during a walk. Some dogs also tend to lick their paws after surgery or after walking in salt that has been applied to streets and sidewalks as ice melt. The present subject matter is designed to handle these common problems.

### SUMMARY OF THE INVENTION

The present subject matter is specifically designed to allow greater protection for a dog and easier accessibility for the owner putting the apparatus on the dog.

### BRIEF DESCRIPTION OF DRAWINGS

FIG. 1 shows a side perspective view of the apparatus in use by a dog.

FIG. 2 shows a front perspective view of the apparatus in use by a dog.

FIG. 3 shows a front perspective view of the apparatus in use by a dog.

FIG. 4 shows a back perspective view of the apparatus in use by a dog.

FIG. 5 shows a front perspective view of the apparatus in use by a dog.

FIG. 6 shows a perspective view of the boot with zipper.

### DETAILED DESCRIPTION OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled”, and variations thereof are not restricted to physical or mechanical connections or couplings.

The present subject matter comprises of a back strap 5, shoulder straps (10,11), chest strap 15, hind leg straps (20, 21), detachable buckles (25, 26, 27, 28), chest strap adjuster 30, shoulder strap adjusters (35, 36), back strap adjuster 40, hind leg strap adjusters (45,46), boots (50, 51, 52, 53), hook and loop fasteners (55, 56, 57, 58, 59, 60, 61, 62), zippers (65, 66, 67, 68), draw strings (70, 71, 72, 73) protective soles 75, reflective surface 80, and water-resistant material 85.

Zippers (65, 66, 67, 68) allow the user to more easily guide their dog's paws into the boot. Detachable buckles (25, 26, 27, 28) also allow for the user to place the boots over the paws of the dog before attaching the harness. Additionally, hook and loop fasteners (55, 56, 57, 58, 59, 60, 61, 62) allow for the user to accommodate different thicknesses of a dog's leg and adjust how tightly they want to strap the boot to the dog.

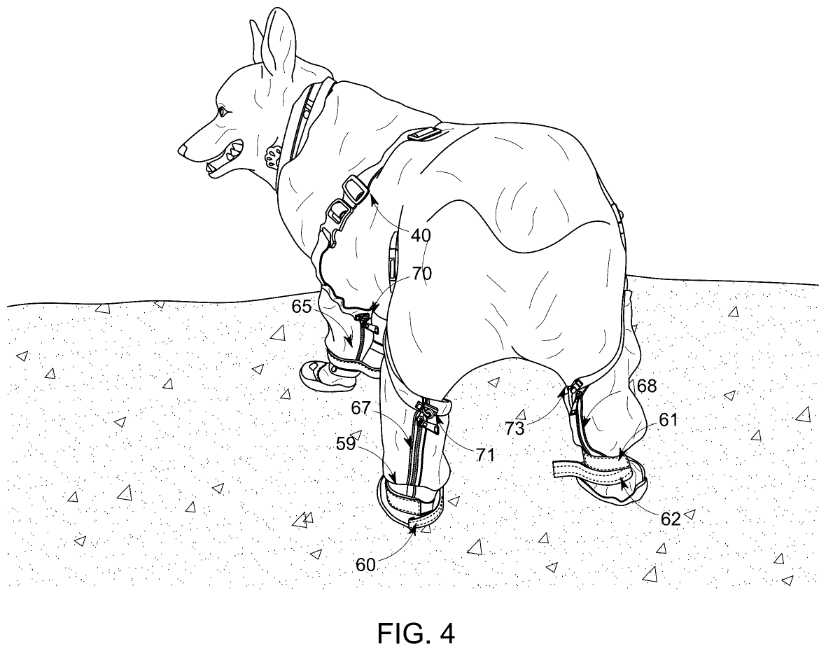

In some embodiments, the front boots have a length of 3.5″, a width of 2.5″, and a height of 2″. In some embodiments, the length of the boot from the heel to upper leg as seen in FIG. 4 is 5″. In some embodiments, the length from the hook and loop fastener 56 to chest strap 15 is 8″. In some embodiments, the length of chest strap 15 is 10″. In some embodiments, the length from detachable buckle 25 to detachable buckle 28 is 14″. In some embodiments, the length from detachable buckle 26 to detachable buckle 27 is 16″. In some embodiments, the length of back strap 5 is 8″. While the lengths above are designed for a medium sized dog, these sizes may be adjusted to fit different sized dogs.

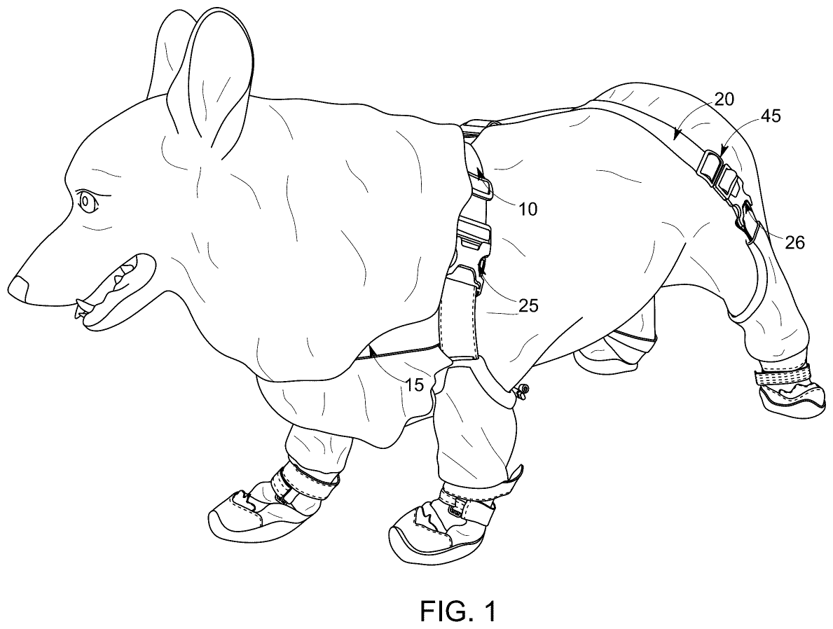

FIG. 1 shows a side perspective view of the apparatus in use by a dog wherein the back strap, shoulder straps, hind leg straps, and chest strap are made of elastic material to accommodate dogs of different sizes and helps prevent a dog from shifting or wriggling out of their protective boots.

FIG. 1 shows shoulder strap adjusters 35 connected to detachable buckle 25. Detachable buckle 25 connects to chest strap 15 which in turn connects to boots (50, 51). Boots (50, 51) have zippers (65, 66) located on the exterior of the boot to increase the opening to more easily slide a dog's paw into the boot.

Once a dog's paws are slid into the boots (50, 51, 52, 53), hook and loop fasteners (55, 56, 57, 58, 59, 60, 61, 62) are secured, zippers (65, 66, 67, 68) are fastened, draw strings (70, 71, 72, 73) designed to prevent snow or water getting into the boot are pulled tight, and detachable buckles (25, 26, 27, 28) are attached, a leash may be attached and a dog is able to go for a walk without having to worry about environmental hazards.

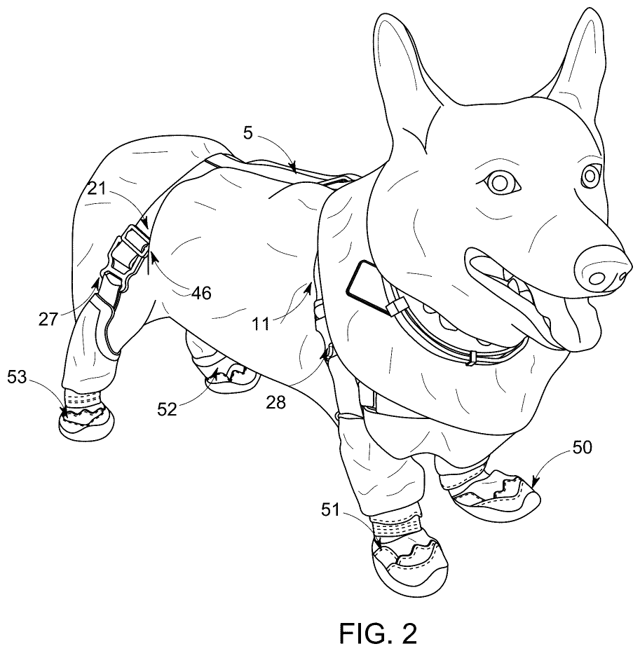

FIG. 2 shows a front perspective view of the apparatus in use by a dog wherein reflective surface 80 is placed on the boots and hook and loop fasteners so that drivers and other pedestrians can more easily see the animal in low light conditions.

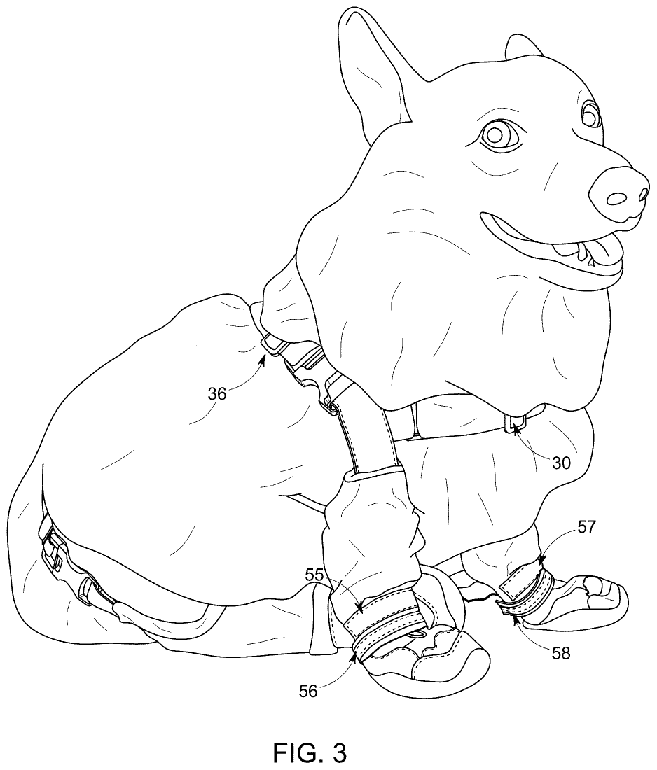

FIG. 3 shows a front perspective view of the apparatus in use by a dog wherein the additional flexibility of the elastic straps allows the dog to comfortably sit.

FIG. 4 shows a back perspective view of the apparatus in use by a dog wherein protective soles 75 allow the dog to comfortably stand on sharp gravel.

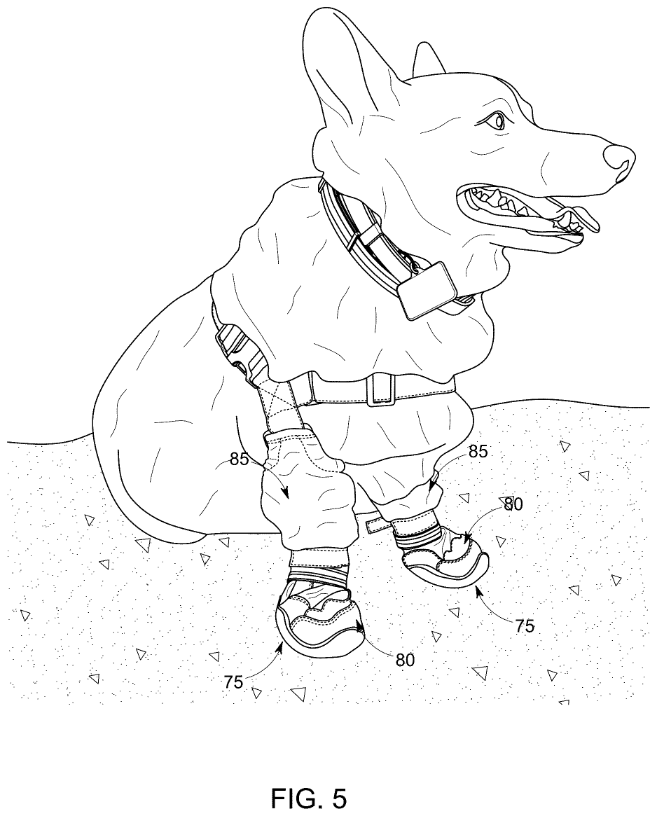

FIG. 5 shows a front perspective view of the apparatus in use by a dog wherein the dog is able to comfortably sit on a gravel surface.

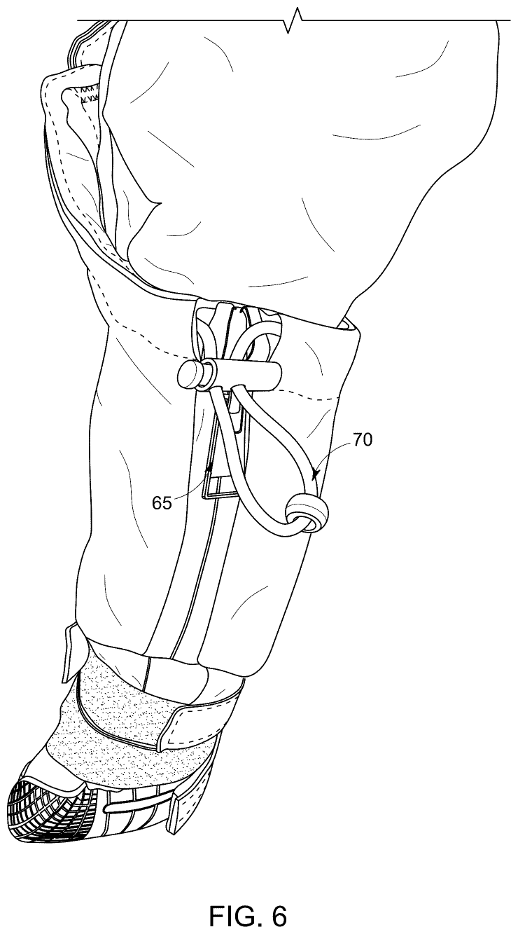

FIG. 6 shows a perspective view of the boot with zipper 65 and draw string 70.

1. Boots with suspenders for protecting a dog's paws comprising a back strap, hook and loop fasteners attached to said the back strap, one or more shoulder straps attached to said back strap on at least one end and attached to one end of the hook and loop fastener at the other, a chest strap directly or indirectly attached to said one or more should straps, hind leg straps attached to said back strap, detachable buckles located in between the boots and the hook and loop fastener, chest strap adjuster located at the junction between the chest strap and back strap, shoulder strap adjusters, back strap adjuster, hind leg strap adjusters, boots, zippers, draw strings, protective soles, reflective surface, and water-resistant material, and the back strap, shoulder straps, hind leg straps, and chest strap are made of an elastic material.

2. The boots with suspenders as in claim 1, wherein detachable buckles, located between the back strap and chest strap, allow for the boots to be put on before attaching the harness.

3. The boots with suspenders as in claim 1, wherein the boots have zippers located on the exterior of the boot and draw strings to adjust the shape, tension, and connections of the boot and the rest of the harness.

4. The boots with suspenders as in claim 3, wherein the hook and loop fasteners along with the book have a reflective surface and display the position of the zippers.

5. The boots with suspenders as in claim 4, wherein drawstrings and water-resistant material prevent moisture from entering the boot.

6. (canceled)
